(19) United States
(12) Patent Application Publication
(10) Pub. No.: US 2007/0072557 A1
(43) Pub. Date: Mar. 29, 2007

(54) Wireless microphone device having built-in memory element

(75) Inventor: Cheng-Shun Chiu, Panchiao City (TW)

Correspondence Address: LEONG C LEI, PMB # 1008, 1867 YGNACIO VALLEY ROAD, WALNUT CREEK, CA, 94598, US

(73) Assignee: NINGBO PROMIC TECHNOLOGY CO., LTD.

(21) Appl. No.: 11/193,499

(22) Filed: Aug. 1, 2005

(51) Int. Cl. H04B 1/46; H04L 12/58

(52) U.S. Cl. 455/79; 455/412.1

(57) ABSTRACT

A wireless microphone device having a built-in memory element is provided herein. The wireless microphone device mainly contains a memory element for storing digital audio information. The stored audio information is retrieved and processed by a decoder element of the wireless microphone device, and then sent out via radio frequency signals by a transmitter element of the wireless microphone device. The audio information could be transmitted asynchronously or synchronously with a user's voice collected by the wireless microphone device. The transmitted radio frequency signals are then received by an external receiver device and played out via a speaker device.

### BACKGROUND OF THE INVENTION

(a) Technical Field of the Invention

The present invention generally relates to a wireless microphone device having a built-in memory element, and more particularly to such a microphone device that could transmit a user's voice along with audio information stored in the memory element synchronously or asynchronously to a receiver device which plays the received signals via a speaker device.

(b) Description of the Prior Art

A conventional microphone device usually contains a collector element and a transmitter element. A user's voice is first collected by the collector element and then transmitted out using radio frequency signals by the transmitter element. The transmitted signals are received by an external receiver device and played out via a speaker device. Such a wireless microphone device is commonly used along with a karaoke machine where the user uses the wireless microphone device to sing along the music played by the karaoke machine. The music played by the karaoke machine is usually pre-recorded on CDs or cassettes, and a user has to swap the CDs or cassettes frequently in order to find and play the desired music, which is quite inconvenient.

On the other hand, some users would use a microphone device to read along some language training recordings while they are repeatedly played by a language learning machine in order to correct and improve the users' pronunciation and accent. Again, the microphone device is only for voice collection. The major language leaning function still lies within the language leaning machine. As suggested by the recent advancement in the portable personal audio/video devices such as MP3 players where large amount of audio information could be digitized, stored, and played, a microphone device could actually provide additional functionality than just a voice collector.

### SUMMARY OF THE INVENTION

The primary purpose of the present invention is to provide a wireless microphone device having a built-in memory element. The wireless microphone device mainly contains a memory element for storing digital audio information. The stored audio information is retrieved and processed by a decoder element of the wireless microphone device, and then sent out via radio frequency signals by a transmitter element of the wireless microphone device. The audio information could be transmitted synchronously or asynchronously along with a user's voice collected by the wireless microphone device. The transmitted radio frequency signals are then received by an external receiver device and played out via a speaker device.

In terms of application, the wireless microphone device of the present invention could be applied in the following exemplary scenarios.

By downloading music or songs into the memory element and playing the music or songs via wireless transmission to external speaker device, the wireless microphone device functions like a cassette tape or CD player.

By downloading music or songs into the memory element, mixing the music or songs synchronously with a user's singing voice, and playing the mixed audio signals via wireless transmission to external speaker device, the wireless microphone device is ideal for use with a karaoke machine.

By downloading language training recordings into the memory element, and selectively switching between the playing of the stored language training recordings and the user's speech via wireless transmission to external speaker device, the wireless microphone device is ideal for language learning.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram of the wireless microphone device according to the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

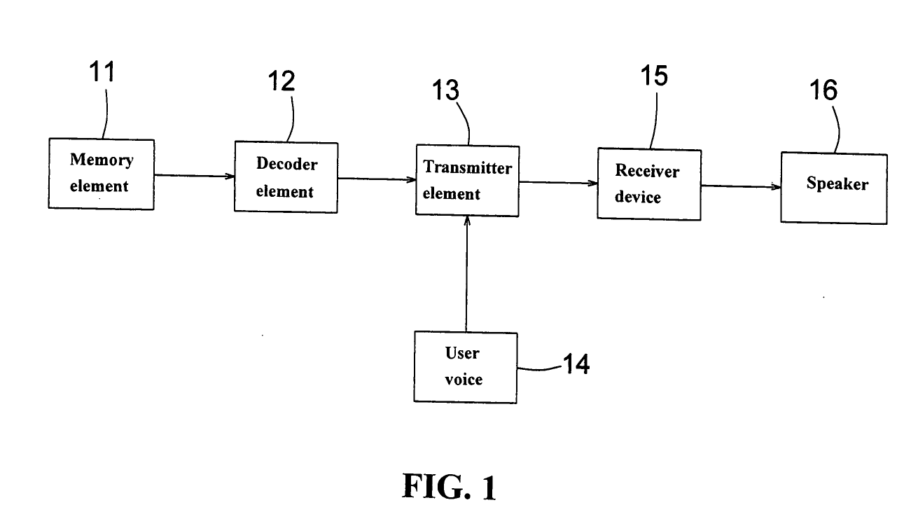

FIG. 1 is a functional block diagram of the wireless microphone device according to the present invention. As shown, the wireless microphone device mainly contains a memory element 11 for storing digital audio information. The stored audio information is retrieved and processed by a decoder element 12 of the wireless microphone device, and then sent out via radio frequency signals by a transmitter element 13 of the wireless microphone device. Determined by a user of the wireless microphone device, the audio information could be mixed and transmitted synchronously along with a user's voice collected by the wireless microphone device. The transmitted radio frequency signals are then received by an external receiver device 15 and played out via a speaker device 16. This synchronous mode of operation of the wireless microphone device is ideal for use with a karaoke machine. On the other hand, a user could also determine that the audio information and user's voice are transmitted asynchronously. By asynchronously, it means that the transmitter device 13 either transmits the stored audio information or the collected user voice, but not both simultaneously. This asynchronous mode of operation is ideal for language learning.

In an embodiment of the present invention, a MP3 decoder chip (such as the SPCA755 chip developed by the Sunplus Technology Co., Ltd, a consumer IC company based in Taiwan) could be used as the decoder element 12 for decoding MP3-formatted audio information stored in the memory element 11. However, the present invention does not require the use of any specific chip. Any appropriate decoder chip could be adopted for the present invention.

The wireless microphone device referred by the present invention could be any wireless microphone device that is handheld, hung on the belt, or worn on the user's head. The present invention does not require the wireless microphone device to be packaged or used in any specific manner.

The digital audio information could be stored in the memory element 11 by using an appropriate USB connector to connect the wireless microphone device with a computing device and downloading the audio information from the computing device to the memory element 11. Besides using USB, other appropriate connection mechanisms such as infrared and Bluetooth could be adopted as well. The present invention does not require any specific connection mechanism for downloading audio information into the memory element 11. The present invention also does not require the audio information to be of any specific format. Any appropriate format such as MP3, WMA, ASF, etc. could be supported.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wireless microphone device comprising a memory element, a decoder element, and a transmitter element, wherein
said memory element stores digital audio information; the stored audio information is retrieved and processed by said decoder element, and then sent out via radio frequency signals by said transmitter element; the audio information is mixed and transmitted synchronously along with a user's voice collected by said wireless microphone device; and the transmitted radio frequency signals are then received by an external receiver device and played out via a speaker device.

2. The wireless microphone device according to claim 1, wherein said wireless microphone device is a handheld wireless microphone device.

3. The wireless microphone device according to claim 1, wherein said wireless microphone device is hung on a user's belt.

4. The wireless microphone device according to claim 1, wherein said wireless microphone device is worn on a user's head.

5. The wireless microphone device according to claim 1, wherein said decoder element supports the decoding of audio information in one of the following formats: MP3, WAV, and ASF.

6. A wireless microphone device comprising a memory element, a decoder element, and a transmitter element, wherein
said memory element stores digital audio information; the stored audio information is retrieved and processed by said decoder element, and then sent out via radio frequency signals by said transmitter element; the audio information is transmitted asynchronously with a user's voice collected by said wireless microphone device; and the transmitted radio frequency signals are then received by an external receiver device and played out via a speaker device.

7. The wireless microphone device according to claim 6, wherein said wireless microphone device is a handheld wireless microphone device.

8. The wireless microphone device according to claim 6, wherein said wireless microphone device is hung on a user's belt.

9. The wireless microphone device according to claim 6, wherein said wireless microphone device is worn on a user's head.

10. The wireless microphone device according to claim 6, wherein said decoder element supports the decoding of audio information in one of the following formats: MP3, WAV, and ASF.

11. A wireless microphone device comprising a memory element, a decoder element, and a transmitter element, wherein
said memory element stores digital audio information; the stored audio information is retrieved and processed by said decoder element, and then sent out via radio frequency signals by said transmitter element; the audio information is transmitted based on a user's selection to be in one of an asynchronous manner and a synchronous manner with a user's voice collected by said wireless microphone device; and the transmitted radio frequency signals are then received by an external receiver device and played out via a speaker device.
